(19) United States
(12) Patent Application Publication
(10) Pub. No.: US 2011/0251754 A1
(43) Pub. Date: Oct. 13, 2011

(54) SYSTEM AND METHOD FOR RECORDING HISTORY OF REFUELING OF VEHICLE USING FLEX FUELS

(75) Inventor: Caruthers Coleman Jones, Bingham Farms, MI (US)

(73) Assignee: GM GLOBAL TECHNOLOGY OPERATIONS, INC., DETROIT, MI (US)

(21) Appl. No.: 12/755,727

(22) Filed: Apr. 7, 2010

(51) Int. Cl. G06F 19/00; G01C 21/00

(52) U.S. Cl. 701/35; 701/213

(57) ABSTRACT

A vehicle refueling recording system includes a sensor that senses a fuel composition of fuel in a fuel tank of a flex fuel vehicle. A refuel detecting module detects a plurality of refueling events. A refueling history module stores a plurality of data sets in response to the plurality of refueling events. Each of the data sets includes a refuel quantity and at least one of a fuel type and a flex fuel percentage.

### FIELD

The present disclosure relates to vehicles, and more particularly to systems and methods for recording a history of refueling of a vehicle that uses flex fuels.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Flex fuel vehicles include an internal combustion engine that is adapted to use more than one type of fuel. For example only, some vehicles may be adapted to use gasoline, ethanol in various percentages, biofuel, compressed natural gas, and/or other flex fuel types. Fuel control systems are commonly used in gasoline-powered vehicles to maintain an air-to-fuel (A/F) ratio near stoichiometry. Stoichiometric values, however, vary depending upon the particular fuel composition that is used.

Fuel composition can also change over time. For example, an operator of a vehicle may need to use gasoline when ethanol is not available. Alternately, the ethanol that is available may have a different mixture of gasoline and ethanol. When fuel is added to a fuel tank, it mixes with fuel already in the tank and creates a mixture. For example, ethanol in varying mixtures can be added to gasoline already in the tank. If the added fuel has a different composition from that of the fuel already in the tank, the engine of the vehicle may operate at a different stoichiometric value after the refueling.

### SUMMARY

A vehicle refueling recording system according to the present disclosure includes a sensor that senses a composition of fuel in a fuel tank of a flex fuel vehicle. A refuel detecting module detects a plurality of refueling events. A refueling history module stores a plurality of data sets in response to the plurality of refueling events. Each of the data sets includes a refuel quantity and at least one of a fuel type and a flex fuel percentage.

In other features, a global positioning system (GPS) module determines a refueling location. The plurality of data sets further includes the refueling locations corresponding to the plurality of refueling events. The plurality of data sets further includes dates corresponding to the refueling events. The plurality of data sets further includes vehicle mileage corresponding to the plurality of refueling events. The sensor comprises a physical fuel sensor arranged in a fuel tank or fuel lines of the flex fuel vehicle. The sensor comprises a virtual fuel sensor module. The virtual fuel sensor module determines the fuel composition based on sensed vehicle parameters.

In other features, the plurality of data sets is read using a service tool. A data set is recorded only when the flex fuel percentage is greater than a predetermined flex fuel percentage. A data set is recorded only when the refuel quantity is greater than a predetermined refuel quantity. An oldest one of the plurality of data sets is deleted when a capacity of a memory storing the plurality of data sets is reached and a new data set is ready for storage. At least one of the plurality of data sets with the lowest flex fuel percentage, the lowest refueling volume or a lowest product of the flex fuel percentage and the refueling volume is deleted when a capacity of a memory storing the plurality of data sets is reached and a new data set is ready for storage.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a vehicle control system that includes a vehicle refueling recording system according to the present disclosure;

FIG. 2 is a functional block diagram of an exemplary implementation of a control module of FIG. 1; and

FIG. 3 is a flowchart illustrating a method for recording refueling history data.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

Some governmental bodies may offer tax credits and/or other incentives for using flex fuels to encourage widespread use. However, the governmental bodies will require proof of flex fuel usage. Proving use of flex fuels may be time consuming for a vehicle owner. In other words, receipts and other documentation may be required by the governmental bodies.

A refueling history recording system and method according to the present disclosure stores refueling data such as date, flex fuel percentage, fuel type (such as ethanol, gasoline, natural gas, biodiesel, etc.), mileage, refuel quantity, and/or location of a plurality of refueling events. In some implementations, the refueling data is stored for refuel events involving flex fuel having a fuel composition above a predetermined flex fuel threshold or adding a refuel quantity greater than a predetermined refuel quantity threshold. The owner, manufacturer, governmental body or other person can download the information from the vehicle as needed. For example only, the information can be accessed during a vehicle emissions check and/or during any other inspection. For example only, the manufacturer can download the information during a service visit using a service tool. A governmental agency can also download the information using a service tool to verify use.

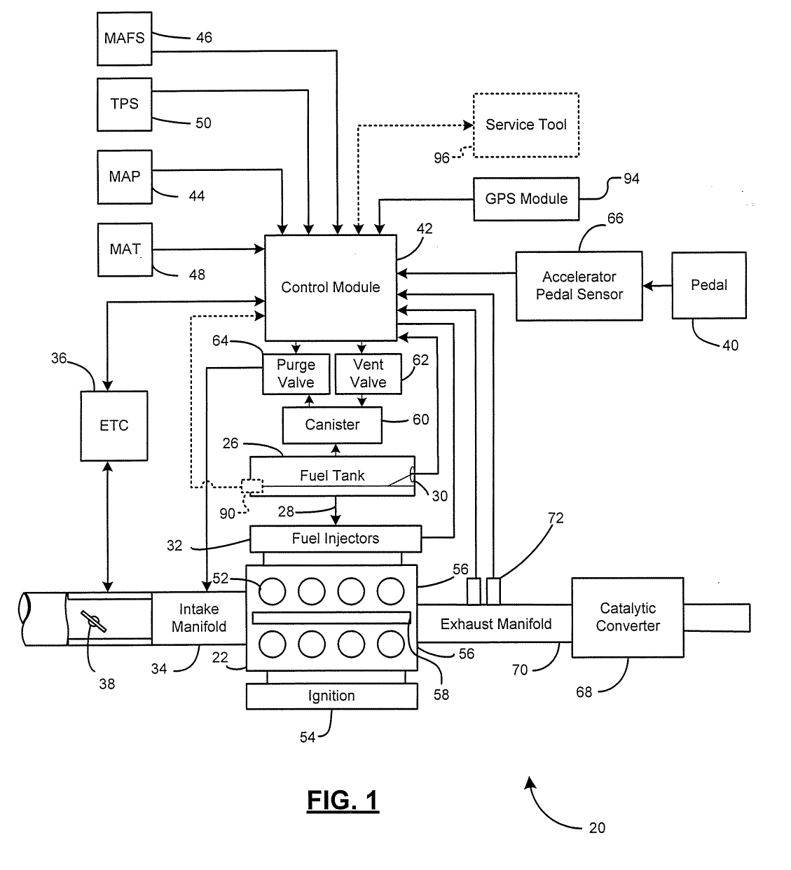

Referring now to FIG. 1, a vehicle 20 including a refueling history storage system is shown. The vehicle 20 may be fueled with gasoline and/or various types of fuel. For example only, the fuel may comprise gasoline, ethanol in various percentages, compressed gas such as compressed natural gas, or biofuel. Fuel is delivered to an engine 22 from a fuel tank 26 through a fuel line 28 and through a plurality of fuel injectors 32. A fuel level sensor 30 senses a level of fuel in the fuel tank 26 and communicates the fuel level to a control module 42. Air is delivered to the engine 22 through an intake manifold 34.

An electronic throttle controller (ETC) 36 adjusts a throttle plate 38 that is located adjacent to an inlet of the intake manifold 34 based upon a position of an accelerator pedal 40 and a throttle control algorithm that is executed by the control module 42. In controlling operation of the vehicle 20, the control module 42 may use a sensor signal 44 indicating pressure in the intake manifold 34. The control module 42 also may use a sensor signal 46 indicating mass air flow (MAF) entering the intake manifold 34 past the throttle plate 38, a signal 48 indicating air temperature in the intake manifold 34, and a throttle position sensor signal 50 indicating an amount of opening of the throttle plate 38.

The engine 22 includes a plurality of cylinders 52 arranged in one or more cylinder banks 56. The cylinders 52 receive fuel from the fuel injectors 32 to drive a crankshaft 58. Vapor from the fuel tank 26 is collected in a canister 60. The canister 60 may be vented to air through a vent valve 62. The canister 60 may be purged through a purge valve 64. When vapor is purged from the canister 60, it is delivered to the intake manifold 34 and burned in the cylinders 52. The control module 42 controls operation of the vent valve 62, purge valve 64, fuel injectors 32 and ignition system 54. The control module 42 communicates with an accelerator pedal sensor 66 that senses a position of the accelerator pedal 40 and sends a signal representative of the pedal position to the control module 42.

A catalytic converter 68 receives exhaust from the engine 22 through an exhaust manifold 70. Oxygen sensors 72 are associated with corresponding cylinder banks 56. The oxygen sensors 72 sense exhaust in the exhaust manifold 70 and deliver signals to the control module 42 indicative of whether the exhaust is lean or rich. The signal output of the oxygen sensors 72 is used by the control module 42 as feedback to regulate fuel delivery to each cylinder bank 56, via fuel injectors 32.

In some implementations, the oxygen sensors 72 are switch-type oxygen sensors. The control module 42 may use feedback from the oxygen sensor 72 to drive an actual air-fuel (A/F) ratio to a desired value, usually around a stoichiometric value. A plurality of predefined engine operating regions is referred to by the control module 42 in controlling fuel delivery to the engine 22. Operating regions may be defined, for example, based on a speed and/or load of the engine 22. The control module 42 may perform control functions that vary based on the operating region of the vehicle.

A global positioning system (GPS) module 94 may be provided to identify vehicle location. A service tool 96 may be connected to download refuel history data. For example only, the service tool 96 may be connected at a service location.

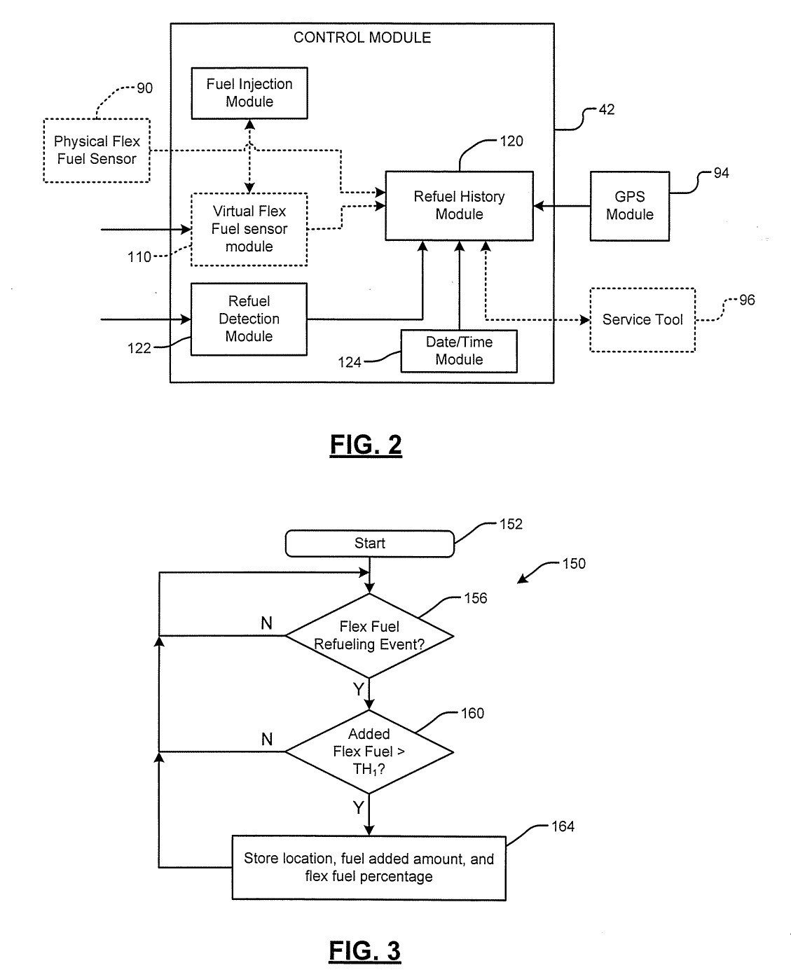

A physical flex fuel sensor 90 may be used to directly sense fuel refill composition. Alternately, a virtual flex fuel sensor module (shown below in conjunction with FIG. 2) may be implemented by the control module 42 to estimate flex fuel composition from other vehicle parameters. In some implementations, the virtual flex fuel sensor module may function as described in U.S. Pat. No. 7,159,623, issued on Jan. 9, 2007 and entitled “Apparatus and Methods for Estimating Vehicle Fuel Composition”, which is hereby incorporated by reference in its entirety.

When a virtual flex fuel sensor module is used, flex fuel composition is determined indirectly without a physical sensor in the fuel tank or fuel lines. In other words, flex fuel composition is determined indirectly. In one implementation, fuel composition is determined based on fuel trim values, although other methods may be used. Fuel, air and/or re-circulated exhaust to the engine 22 may be adjusted, i.e., trimmed, to correct for deviations from a desired air-fuel ratio. Trim values used to make the corrections may be stored in memory locations of the control module 42 corresponding to a plurality of predefined closed loop air-fuel ratio control cells (also referred to as sub-regions) associated with the operating regions of the vehicle 20. Cell values are used to provide closed-loop fuel, air and/or re-circulated exhaust control.

In one implementation, in order to estimate fuel composition, the control module 42 determines relative changes in fuel trim in terms of fuel/air (F/A). The control module 42 uses the fuel trim relative changes to estimate fuel composition following a refueling event. In one implementation of a method of estimating composition of fuel in the fuel tank 26, a refuel event is detected. Fuel consumption is monitored during a plurality of learn stages after the refuel event, until an amount of fuel consumed after the refuel event exceeds a calibrated threshold. A fuel composition estimate is calculated at the end of each learn stage. Each learn stage is scheduled as a function of fuel consumed after the refuel event. Purging of the canister 60 is commanded off during each learn stage to prevent purge vapors from corrupting an estimate of flex fuel composition.

Alternately, other virtual flex fuel sensing methods can be performed or the physical flex fuel sensor 90 can be used to estimate flex fuel composition. The amount of fuel that is added may be calculated by the difference in fuel level (e.g. an increase above a predetermined amount).

Referring now to FIG. 2, the control module 42 receives the fuel composition estimate from the physical flex fuel sensor 90 or a virtual flex fuel sensor module 110 estimates flex fuel composition indirectly based on other sensed vehicle parameters. A fuel injection module 112 controls fuel injection. A refuel history module 120 stores a plurality of data sets including refuel data. For example only, the data sets can include refuel data such as date, time, mileage, fuel type, flex fuel percentage, refuel quantity, and/or location of refueling events. In some implementations, the refuel data is stored only for refuel events above a predetermined flex fuel threshold or predetermined refuel quantity threshold.

A refuel event detection module 122 senses changes in fuel level in the fuel tank to identify fuel refill events. For example only, a refuel event may be declared when the fuel level increases by a predetermined amount. A date/time module 124 provides date and/or time information. The GPS module 94 provides location data as needed. The service tool 96 may be selectively connected to the control module 42 to read back stored data.

Referring now to FIG. 3, a method 150 for recording a history of refuel data for a vehicle according to the present disclosure is shown. Control begins at 152. At 156, control determines whether a flex fuel refueling event has occurred. As can be appreciated, other implementations may record all refuel events even if gasoline is used. If false, control returns to 156. If true, control continues with 160 and determines whether a sufficient amount of additional fuel has been added. As can be appreciated, other implementations may record any event involving adding additional fuel. If false, control returns to 156. If true, control continues at 164 and stores refuel data in the refuel history module 120.

In some implementations, an oldest refueling data set may be deleted when a capacity of a memory allocated to the refueling history is reached and a new refueling data set is ready for storage. In other implementations the refueling data with the lowest flex fuel percentage, the lowest refueling volume, or a lowest product of the flex fuel percentage and refueling volume may be deleted.

As can be appreciated, the present disclosure records flex fuel usage over time. Furthermore, the owner of the vehicle can provide proof of flex fuel usage with little or no user involvement. The proof may be used to apply for credit for alternative fuel use, such as for CO₂ (fuel economy) credits in certain jurisdictions. By automatically recording the information in the flex fuel history module, other more difficult alternatives can be avoided such as requiring the vehicle owner to manually record and document fuel purchase history. While the present disclosure has been described in conjunction with flex fuels such as ethanol, the present disclosure applied to other flex fuels such as biofuel.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A vehicle refueling recording system, comprising:
a sensor for sensing a fuel composition of fuel in a fuel tank of a flex fuel vehicle;
a refuel detecting module that detects a plurality of refueling events; and
a refueling history module that stores a plurality of data sets in response to the plurality of refueling events, wherein each of the data sets includes a refuel quantity and at least one of a fuel type and a flex fuel percentage.

2. The vehicle refueling recording system of claim 1, further comprising a global positioning system (GPS) module, wherein the plurality of data sets further include refueling locations corresponding to the plurality of refueling events.

3. The vehicle refueling recording system of claim 1, wherein the plurality of data sets further include vehicle mileage corresponding to the plurality of refueling events.

4. The vehicle refueling recording system of claim 1, wherein the sensor comprises one of a physical fuel sensor arranged in a fuel tank of a vehicle and a virtual fuel sensor module.

5. The vehicle refueling recording system of claim 1, wherein the plurality of data sets comprise dates corresponding to the plurality of refueling events.

6. The vehicle refueling recording system of claim 4, wherein the virtual fuel sensor module determines the fuel composition based on fuel trim values.

7. The vehicle refueling recording system of claim 1, wherein the plurality of data sets are read using a service tool.

8. The vehicle refueling recording system of claim 1, wherein a data set is recorded only when the flex fuel percentage is greater than a predetermined flex fuel percentage.

9. The vehicle refueling recording system of claim 1, wherein a data set is recorded only when the refuel quantity is greater than a predetermined refuel quantity.

10. The vehicle refueling recording system of claim 1, wherein an oldest one of the plurality of data sets is deleted when a capacity of a memory storing the plurality of data sets is reached and a new data set is ready for storage.

11. The vehicle refueling recording system of claim 1, wherein at least one of the plurality of data sets with the lowest flex fuel percentage, the lowest refueling volume or a lowest product of the flex fuel percentage and the refueling volume is deleted when a capacity of a memory storing the plurality of data sets is reached and a new data set is ready for storage.

12. A method for recording vehicle refueling, comprising:
sensing a fuel composition of fuel in a fuel tank of a flex fuel vehicle;
detecting a plurality of refueling events; and
storing a plurality of data sets in response to the plurality of refueling events,
wherein each of the plurality of data sets includes a refuel quantity and at least one of a fuel type and a flex fuel percentage.

13. The method of claim 12, further comprising:
generating refueling location data during the refueling events; and
storing the refueling location data in the plurality of data sets.

14. The method of claim 12, further comprising:
generating mileage data during the refueling events; and
storing the mileage data in the plurality of data sets.

15. The method of claim 12, further comprising using at least one of a physical fuel sensor arranged in a fuel tank of a vehicle and a virtual fuel sensor.

16. The method of claim 12, wherein the plurality of data sets comprises dates corresponding to the plurality of refueling events.

17. The method of claim 15, wherein the virtual fuel sensor module determines fuel composition based on fuel trim values.

18. The method of claim 12, further comprising reading the plurality of data sets using a service tool.

19. The method of claim 12, further comprising recording a data set only when the flex fuel percentage is greater than a predetermined flex fuel percentage.

20. The method of claim 12, further comprising recording a data set only when the refuel quantity is greater than a predetermined refuel quantity.

21. The method of claim 12, further comprising deleting an oldest one of the plurality of data sets when a capacity of a memory storing the plurality of data sets is reached and a new data set is ready for storage.

22. The method of claim 12, further comprising deleting at least one of the plurality of data sets with the lowest flex fuel percentage, the lowest refueling volume or a lowest product of the flex fuel percentage and the refueling volume when a capacity of a memory storing the plurality of data sets is reached and a new data set is ready for storage.
